(19) United States
(12) Patent Application Publication
(10) Pub. No.: US 2023/0262576 A1
(43) Pub. Date: Aug. 17, 2023

(54) USER EQUIPMENT-TO-NETWORK RELAY FOR EMERGENCY SERVICES

(71) Applicant: Apple Inc., Cupertino, CA (US)

(72) Inventors: Sudeep Manithara Vamanan, Nuremberg (DE); Babar Qaisrani, Issaquah, WA (US); Biljana Badic, Munich (DE); Haijing Hu, Los Gatos, CA (US); Krisztian Kiss, Hayward, CA (US); Vivek G. Gupta, San Jose, CA (US); Zhibin Wu, Los Altos, CA (US)

(73) Assignee: Apple Inc., Cupertino, CA (US)

(21) Appl. No.: 18/078,899

(22) Filed: Dec. 9, 2022

Related U.S. Application Data
(60) Provisional application No. 63/310,015, filed on Feb. 14, 2022.

(51) Int. Cl. H04W 40/22; H04M 3/51; H04W 4/90; H04W 40/24

(52) U.S. Cl. CPC H04W 40/22; H04M 3/5116; H04W 4/90; H04W 40/246; H04W 88/04

(57) ABSTRACT

The present application relates to improving coverage and reliability of cellular emergency service. In an example, a relay UE is authorized by a core network to provide a U2N relay for emergency services, where this authorization is based on UE capability information sent to the core network indicating the support of U2N relay emergency functionalities. During a U2N relay discovery, the relay UE indicates, to a remote UE, that this capability can be provided. Accordingly, the remote UE selects the relay UE from a candidate set of relay UEs and a relay communication is established.

### CROSS-REFERENCES TO RELATED APPLICATION

This application claims priority from U.S. Provisional Patent Application No. 63/310,015, filed Feb. 14, 2022, the entire contents of which is herein incorporated by reference for all purposes.

### TECHNICAL FIELD

The present application relates to the field of wireless technologies and, in particular, to user equipment-to-network relay for emergency services.

### BACKGROUND

Cellular communications can be defined in various standards to enable communications between a user equipment and a cellular network. For example, Fifth generation mobile network (5G) is a wireless standard that aims to improve upon data transmission speed, reliability, availability, and more.

### BRIEF DESCRIPTION OF THE DRAWINGS

FIG. 1 illustrates an example of a 5G network architecture that incorporates both 3GPP (e.g., cellular) and non-3GPP (e.g., non-cellular) access to the 5G core network, in accordance with some embodiments.

FIG. 2 illustrates an example of a 5G network architecture that incorporates both dual 3GPP (e.g., LTE and 5G NR) access and non-3GPP access to the 5G core network, in accordance with some embodiments.

FIG. 3 illustrates an example of a baseband processor architecture for a UE, in accordance with some embodiments.

FIG. 4 illustrates an example of a signaling and communication sequence diagram for emergency communications over a user equipment (UE)-to-network relay, in accordance with some embodiments.

FIG. 5 illustrates an example of a sequence diagram for emergency services over a layer 3 UE-to-network relay, in accordance with some embodiments.

FIG. 6 illustrates an example of a sequence diagram for emergency services over a layer 2 UE-to-network relay, in accordance with some embodiments.

FIG. 7 illustrates an example of a sequence diagram for a UE-to-network relay discovery that uses model A, in accordance with some embodiments.

FIG. 8 illustrates an example of a sequence diagram for a UE-to-network relay discovery that uses model B, in accordance with some embodiments.

FIG. 9 illustrates another example of a sequence diagram for a UE-to-network relay discovery that uses model A, in accordance with some embodiments.

FIG. 10 illustrates another example of a sequence diagram for a UE-to-network relay discovery that uses model B, in accordance with some embodiments.

FIG. 11 illustrates an example of an operational flow/algorithmic structure for a relay UE to participate in relay communications, in accordance with some embodiments.

FIG. 12 illustrates an example of an operational flow/algorithmic structure for a remote UE to participate in relay communications, in accordance with some embodiments.

FIG. 13 illustrates an example of an operational flow/algorithmic structure for a core network to participate in relay communications, in accordance with some embodiments.

FIG. 14 illustrates an example of receive components, in accordance with some embodiments.

FIG. 15 illustrates an example of a UE, in accordance with some embodiments.

FIG. 16 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a relay architecture can be implemented to improve coverage and reliability by using a multi-hop like architecture. A user equipment (UE)-to-network relay (also abbreviated as U2N relay) is an example implementation of the relay architecture. In a U2N relay architecture, a first UE that is in a range of cellular coverage is configured to relay, to a network, uplink traffic of a second UE that is out of range of cellular coverage. The first UE is also configured to relay downlink traffic from the network to the second UE. The first UE and the second UE are referred to as a relay UE and a remote UE, respectively. In this way, although the remote UE is out of cellular coverage, access of the remote network to the network remains possible via the relay UE, thereby extending coverage and reliability.

For emergency services, a relay UE can indicate, to the network (e.g., a 5G core network), its capability to support a U2N relay for emergency services. In turn, the network can send authorization information to the relay UE indicating that the U2N relay for emergency services can be provided. Based on the authorization information, during a U2N relay discovery, the relay UE can indicate to a remote UE its support for the U2N relay for emergency services. The remote UE can select the relay UE from candidate relay UEs based on, among other factors, the relay UE's support of the U2N relay for emergency services. Following the selection, the remote UE, the relay UE, and the network can participate in establishing a relay communication that includes a direct connection between the remote UE and the relay UE. Such a connection is accorded a high priority such that emergency traffic can be sent to and from the remote UE via the related relay communication. These and other U2N relay functionalities for emergency services are further described herein below.

Embodiments of the present disclosure are described in connection with 5G networks. However, the embodiments are not limited as such and similarly apply to other types of communication networks including cellular networks.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

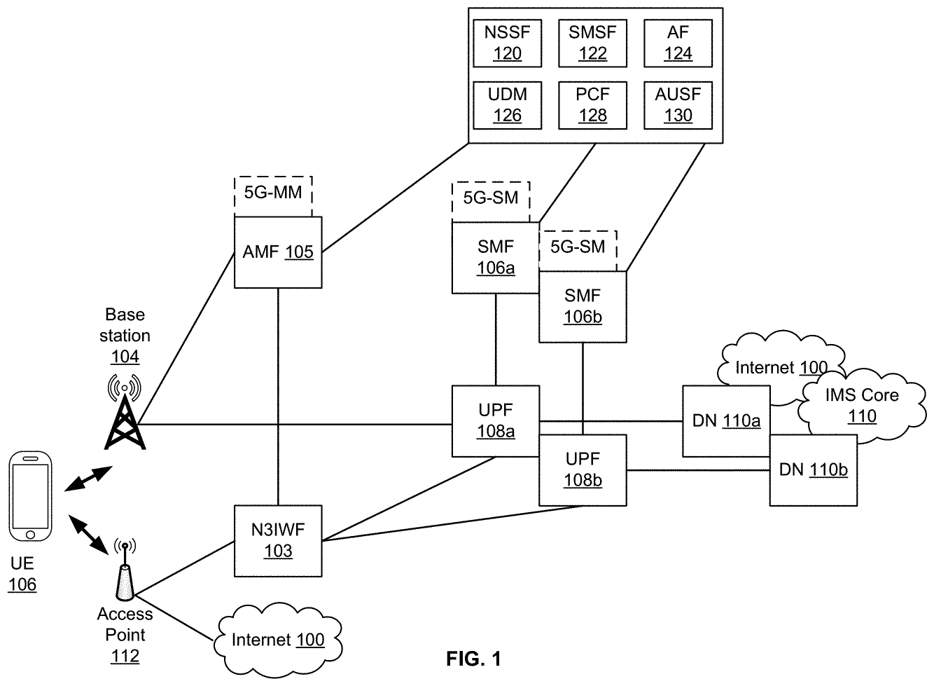

FIG. 1 illustrates an example of a 5G network architecture that incorporates both 3GPP (e.g., cellular) and non-3GPP (e.g., non-cellular) access to a 5G Core network (CN), in accordance with some embodiments. As shown, a UE 106 may access the 5G CN through both a radio access network (RAN, e.g., a base station 104 that can be a gNB) and an access point (AP) 112. The AP 112 may include a connection to the Internet 100 as well as a connection to a non-3GPP inter-working function (N3IWF) 103 network entity. The N3IWF may include a connection to a core access and mobility management function (AMF) 105 of the 5G CN. The AMF 105 may include an instance of a 5G mobility management (5G MM) function associated with the UE 106. In addition, the RAN (e.g., the base station 104) may also have a connection to the AMF 105. Thus, the 5G CN may support unified authentication over both connections as well as allow simultaneous registration for UE 106 access via both gNB 104 and AP 112. As shown, the AMF 105 may include one or more functional entities associated with the 5G CN (e.g., network slice selection function (NSSF) 120, short message service function (SMSF) 122, application function (AF) 124, unified data management (UDM) 126, policy control function (PCF) 128, and/or authentication server function (AUSF) 130). Note that these functional entities may also be supported by a session management function (SMF) 106a and an SMF 106b of the 5G CN. The AMF 105 may be connected to (or in communication with) the SMF 106a. Further, the base station 104 may be in communication with (or connected to) a user plane function (UPF) 108a that may also be in communication with the SMF 106a. Similarly, the N3IWF 103 may be communicating with a UPF 108b that may also be communicating with the SMF 106b. Both UPFs may be communicating with the data network (e.g., DN 110a and 110b) and/or the Internet 100 and Internet Protocol (IP) Multimedia Subsystem/IP Multimedia Core Network Subsystem (IMS) core network 110.

Generally, base station 104 communicates over a transmission medium with one or more UEs (e.g., including the UE 106). Each of the user devices may be referred to herein as a “user equipment” (UE). The base station (BS) 104 may be a base transceiver station (BTS) or cell site (a “cellular base station”) and may include hardware that enables wireless communication with the UE 106.

The communication area (or coverage area) of the base station 104 may be referred to as a “cell.” The base station 104 and the UE 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. If the base station 104 is implemented in the context of LTE, it may alternately be referred to as an ‘eNodeB’ or ‘eNB’. If base station 104 is implemented in the context of 5G NR, it may alternately be referred to as ‘gNodeB’ or ‘gNB’.

The base station 104 may also be equipped to communicate with a network (e.g., a core network of a cellular service provider such as the 5G CN, a telecommunication network such as a public switched telephone network (PSTN), and/or the Internet, among various possibilities). Thus, the base station 104 may facilitate communication between the user devices and/or between the UE 106 and the network. In particular, the cellular base station 104 may provide UEs 106 with various telecommunication capabilities, such as voice, SMS, and/or data services.

The base station 104 and other similar base stations operating according to the same or a different cellular communication standard may thus be provided as a network of cells, which may provide continuous or nearly continuous overlapping service to UE 106 and similar devices over a geographic area via one or more cellular communication standards.

Thus, while base station 104 may act as a “serving cell” for UE 106 as illustrated in FIG. 1, the UE 106 may also be capable of receiving signals from (and possibly within communication range of) one or more other cells, which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size.

In some embodiments, the base station 104 may be a next generation base station, e.g., a 5G New Radio (5G NR) base station, or “gNB”. In some embodiments, a gNB may also be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

The UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

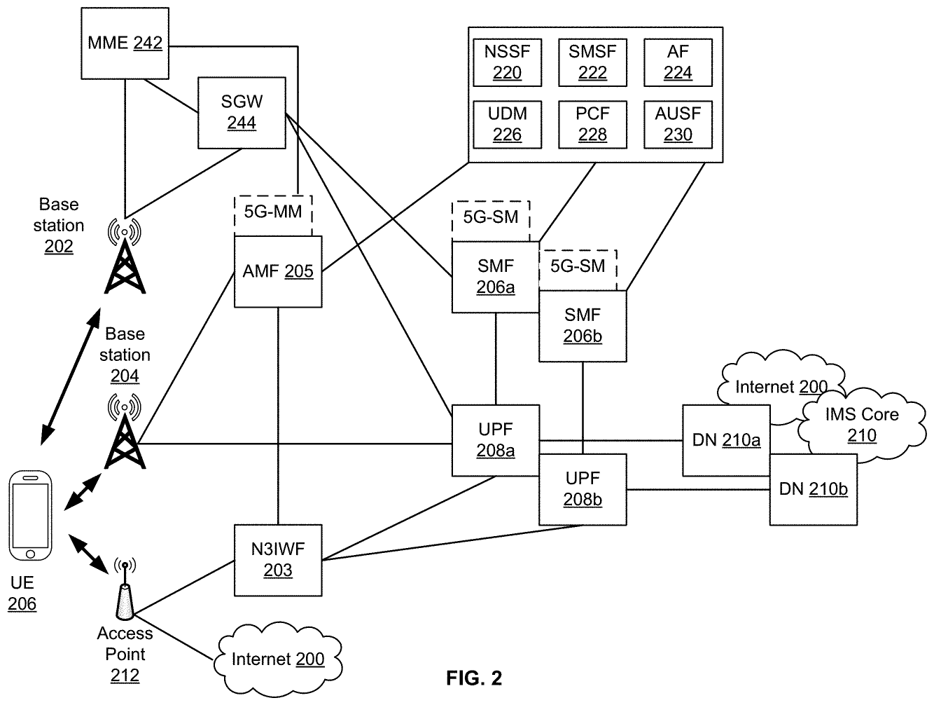

FIG. 2 illustrates an example of a 5G network architecture that incorporates both dual 3GPP (e.g., LTE and 5G NR) access and non-3GPP access to the 5G CN, in accordance with some embodiments. As shown, a UE 206 may access the 5G CN through both a RAN (e.g., a base station 204 such as gNB) and an AP 212. The AP 212 may include a connection to the Internet 200 as well as a connection to a N3IWF 203 network entity. The N3IWF 203 may include a connection to an AMF 205 of the 5G CN. The AMF 205 may include an instance of a 5G MM function associated with the UE 206. In addition, the RAN (e.g., the base station 204) may also have a connection to the AMF 205. Thus, the 5G CN may support unified authentication over both connections as well as allow simultaneous registration for UE 206 access via both the base station 204 and the AP 212. In addition, the 5G CN may support dual-registration of the UE 106 on both a legacy network (e.g., LTE via a base station 202, such as an eNB) and a 5G network (e.g., via the base station 204). As shown, the base station 202 may have connections to a mobility management entity (MME) 242 and a serving gateway (SGW) 244. The MME 242 may have connections to both the SGW 244 and the AMF 205. In addition, the SGW 244 may have connections to both an SMF 206a and an UPF 208a. As shown, the AMF 205 may include one or more functional entities associated with the 5G CN (e.g., NSSF 220, SMSF 222, AF 224, UDM 226, PCF 228, and/or AUSF 230). The UDM 226 may also include a home subscriber server (HSS) function and the PCF 228 may also include a policy and charging rules function (PCRF). These functional entities may also be supported by an SMF 606a and an SMF 206b of the 5G CN. The AMF 206 may be connected to (or in communication with) the SMF 206a. Further, the base station 204 may be in communication with (or connected to) the UPF 208a that may also be in communication with the SMF 206a. Similarly, the N3IWF 203 may be communicating with a UPF 208b that may also be communicating with an SMF 206b. Both UPFs may be communicating with the data network (e.g., DN 210a and 210b) and/or the Internet 200 and an IMS core network 210.

In various embodiments, one or more of the above-described network entities may be configured to perform methods to improve security checks in a 5G NR network, including mechanisms for emergency communications (e.g., voice calls and/or SMS messages) for UEs without cellular coverage (e.g., in non-cellular coverage), e.g., as further described herein.

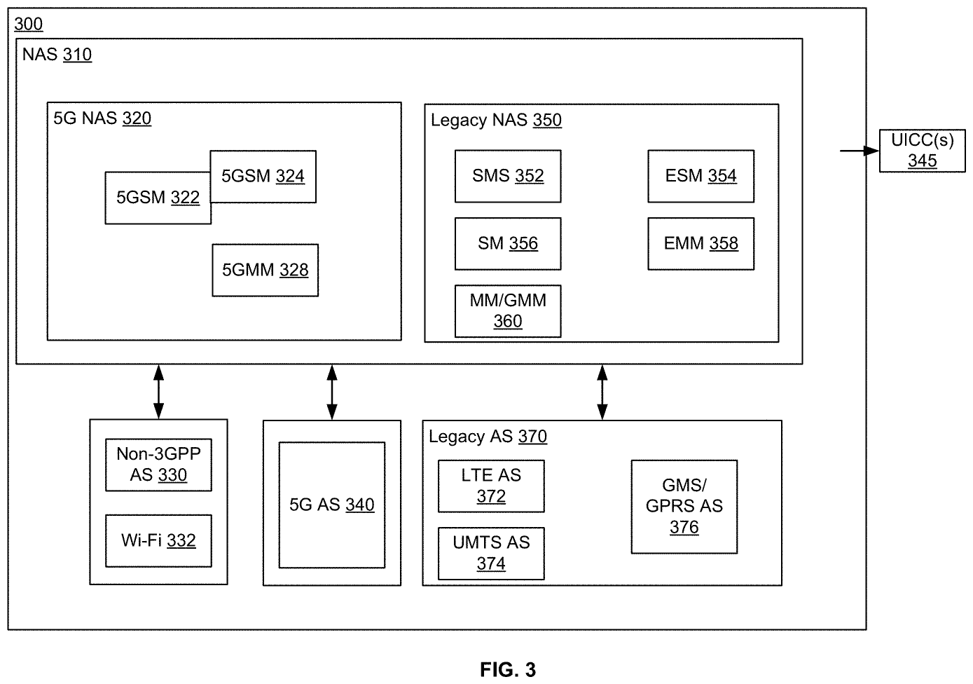

FIG. 3 illustrates an example of a baseband processor architecture for a UE 300 (e.g., such as the UE 106 and the UE 206), in accordance with some embodiments. The baseband processor architecture 300 described in FIG. 3 may be implemented on one or more radios or modems. As shown, a non-access stratum (NAS) 310 may include a 5G NAS 320 and a legacy NAS 350. The legacy NAS 350 may include a communication connection with a legacy access stratum (AS) 370. The 5G NAS 320 may include communication connections with both a 5G AS 340 and a non-3GPP AS 330 and Wi-Fi AS 332. The 5G NAS 320 may include functional entities associated with both access stratums. Thus, the 5G NAS 320 may include multiple 5G MM entities 326 and 328 and 5G session management (SM) entities 322 and 324. The legacy NAS 350 may include functional entities such as short message service (SMS) entity 352, evolved packet system (EPS) session management (ESM) entity 354, session management (SM) entity 356, EPS mobility management (EMM) entity 358, and mobility management (MM)/GPRS mobility management (GMM) entity 360. In addition, the legacy AS 370 may include functional entities such as LTE AS 372, UMTS AS 374, and/or GSM/GPRS AS 376.

Thus, the baseband processor architecture 300 allows for a common 5G-NAS for both 5G cellular and non-cellular (e.g., non-3GPP access). As shown, the 5G MM may maintain individual connection management and registration management state machines for each connection. Additionally, a device (e.g., UE 106) may register to a single public land mobile network (PLMN) using 5G cellular access as well as non-cellular access. Further, it may be possible for the device to be in a connected state in one access and an idle state in another access and vice versa. There may be common 5G-MM procedures (e.g., registration, de-registration, identification, authentication) for both accesses.

In various embodiments, one or more of the above-described functional entities of the 5G NAS and/or 5G AS may be configured to perform methods of emergency communications (e.g., voice calls and/or SMS messages) for UEs without cellular coverage (e.g., in non-cellular coverage), e.g., as further described herein.

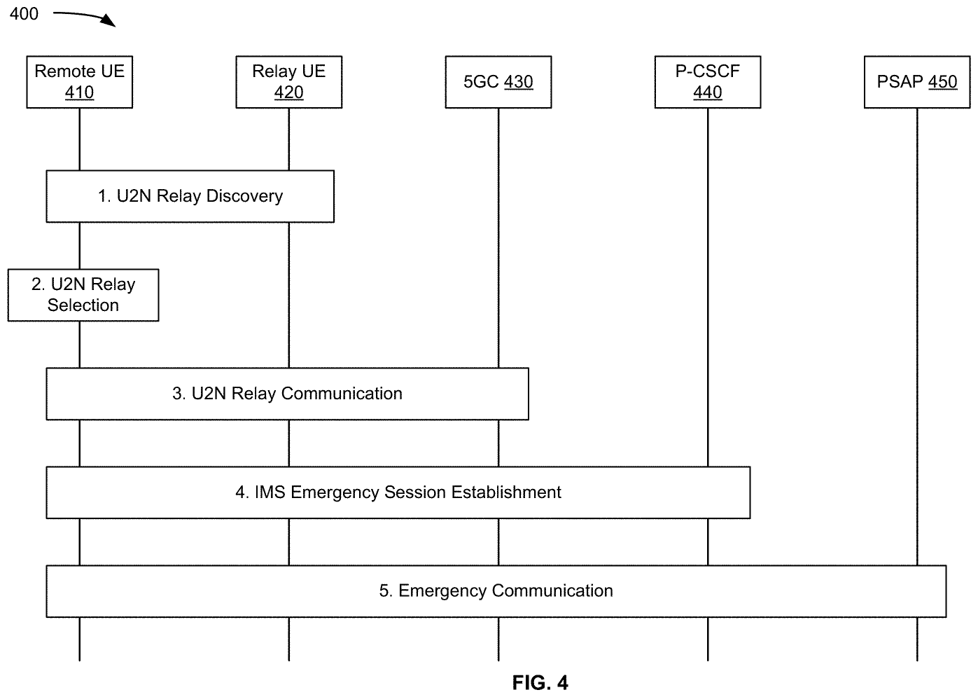

FIG. 4 illustrates an example of a signaling and communication sequence diagram 400 for emergency communications over a U2N relay, in accordance with some embodiments. The signaling and communication sequence diagram 400 involves communications between a remote UE 410, a relay UE 420, a 5G core (5GC) 430, a proxy-call session control function (P-CSCF) module 440, and a public safety answering point/public safety access point (PSAP) 450. For simplicity purposes, a base station is not illustrated in FIG. 4. Nonetheless, similarly to the above-described network architecture, the base station provides a cell on which the relay UE 420 is camped such that the relay UE 420 is within a range of cellular coverage. Communications between the relay UE 420 and the 5GC 430 can be managed at least in part via the base station. In comparison, the remote UE 410 may be outside the range of the cellular coverage and, therefore, may involve the relay UE 420 for emergency services. Each of the remote UE 410 and the relay UE 420 are examples of the UE 106 and include components of the UE 300 described herein above. The 5GC 430 can include components of the 5G core network described in FIGS. 1 and 2. The P-CSCF module 440 can be implemented as specialized hardware or as a combination of hardware and software to provide an ingress and egress point to and from a service provider's IMS domain with respect to an IMS client. The PSAP 450 can also be implemented as specialized hardware or as a combination of hardware and software within a public switch telephone network (PSTN) at which emergency services communication handlers can receive and place emergency calls. The PSAP 450 can also support packet-based connectivity to service frameworks such as the IMS, allowing users of an IMS to make emergency communications (e.g., voice calls, video calls, text messages, etc.) without having to route a call out to the PSTN.

The signaling and communication sequence diagram 400 can be implemented to provide a U2N relay for emergency services to the remote UE 410, whereby emergency communications (e.g., voice calls, video calls, text messages, etc.) to and from the remote UE 410 can be relayed via the relay UE 420 from and to the PSAP 450. Upon a trigger, the remote UE 410 may initiate a U2N relay discovery. The trigger can be an emergency condition, such as placing a call or sending a message to an emergency service (e.g., that of the police, fire department, etc.) while the remote UE 410 is out of the cellular service range. The U2N discovery enables the remote UE to discover one or more candidate relay UEs, including the relay UE 420, based on such devices being configured to provide U2N relay functionalities for emergency services and being within a device-to-device (D2D) connection range, also referred to as peer-to-peer (P2P) connection range relative to the remote UE 410. In some embodiments, the U2N relay discovery may be performed on an unlicensed band of the frequency spectrum. In some embodiments, the U2N relay discovery may be performed based on any combination of and/or all of a dedicated peer-to-peer protocol, cellular based communications, Wi-Fi based communications, Bluetooth, and/or Bluetooth Low Energy based communications, as well as other longer-range and/or shorter-range communication technologies. In some embodiments, the U2N relay discovery may be performed based on and/or in conjunction with the 3GPP PC5 communication protocol. In some embodiments, the U2N relay discovery may be performed using an emergency channel, e.g., as described herein. In some embodiments, during U2N relay discovery, the remote UE 410 may provide information associated with the emergency condition to the candidate relay UEs. For example, the remote UE 410 may provide an indication of a type of emergency, the approximate location of the remote UE 410, and/or other information associated with the emergency condition. An example of a U2N relay discovery is described in 3GPP TS23.304 V17.1.0 (2021December), section 6.3.2.3, the content of which is incorporated herein by reference in its entirety.

Next, the remote UE 410 may select the relay UE 420 from the candidate relay UEs. In some embodiments, the selection of the relay UE 420 may be based on one or more factors, such as signal strength. An example of a U2N relay selection is described in 3GPP TS23.304 V17.1.0 (2021December), section 6.3.2.3, the content of which is incorporated herein by reference in its entirety.

Upon being selected, the relay UE 420 may establish a U2N relay communication between the remote UE 410 and the 5GC 430. Establishing the U2N relay communication can include message exchanges between the remote UE 410 and the relay UE 420 and between the relay UE 420 and the 5GC 430, where the exchanged messages can indicate that the relay communication is established for emergency services. A D2D connection can be established between the remote UE 410 and the relay UE 420 and a network connection (e.g., via a base station) between the relay UE 410 and the 5GC 430 can be associated with the D2D connection such that uplink and downlink traffic can be relayed from and to the remote UE 410 via the relay UE 420. The types of messages and particular establishment procedures can depend on the type of the U2N relay (e.g., a layer 3 U2N relay or a layer 2 U2N relay) as further described in the next figures. Generally, the messages may be transmitted based on any combination of and/or all of a dedicated peer-to-peer protocol, cellular based communications, Wi-Fi based communications, Bluetooth and/or Bluetooth Low Energy based communications, as well as other longer-range and/or shorter-range communication technologies. In some embodiments, the messages may be transmitted based on and/or in conjunction with the 3GPP PC5 communication protocol. In some embodiments, the messages may also be transmitted using an emergency channel. An example of a U2N relay establishment is described in 3GPP TS23.304 V17.1.0 (2021December), section 6.5.1, section 6.5.2, and 3GPP TS 23.502 V17.3.0 (2021December), the contents of which are incorporated herein by reference in their entirety.

Next, an IMS emergency session may be established between the remote UE 410 and the P-CSCF module 440 based on the U2N relay communication. For example, the remote UE 410 may send an IMS registration request message to the relay UE 420, which the relay UE 420 may then forward to 5GC 430. The relay UE 420 may perform IMS registration with the 5GC 430 on behalf of the remote UE 410. The 5GC 430 may also register the IMS emergency session with the P-CSCF module 440. An example of an IMS emergency session establishment is described in 3GPP TS 23.502 V17.3.0 (2021 December) and 3GPP TS 23.167 V17.2.0 (2021 September), the contents of which are incorporated herein by reference in their entirety. Subsequently, emergency communications (e.g., a voice call, a video call, and/or text message) can be supported between the remote UE 410 and the PSAP 450, whereby the related traffic is exchanged using communication protocols supported by the IMS emergency session.

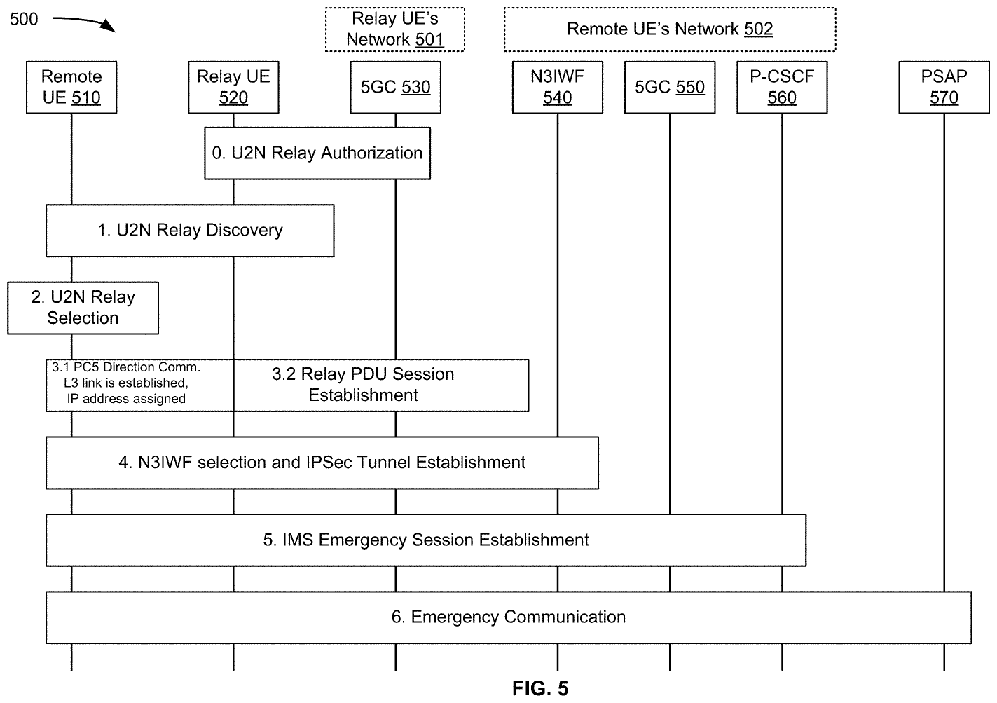

FIG. 5 illustrates an example of a sequence diagram 500 for emergency services over a layer 3 UE-to-network relay, in accordance with some embodiments. The sequence diagram 500 enables multiple enhancements relative to the sequence diagram 400. The enhancements are further described herein below. Similarities between the two sequence diagrams 400 and 500 are not repeated in the interest of brevity of explanation. The sequence diagram 500 involves communications between a remote UE 510, a relay UE 520, a 5G core (5GC) 530, an N3IWF module 540, a 5GC 550, a P-CSCF module 560, and a PSAP 570. The 5G core 530 can be part of the relay UE's 520 network. In comparison, the N3IWF module 540, the 5GC 550, and the P-CSCF module 560 can be parts of the remote UE's 410 network. The relay UE's 520 network and the remote UE's 510 network may but need not be the same (if they are the same, then the 5GC 550 is the same as 5GC 530; otherwise, they can be different). In FIG. 5, the relay UE 520 provides a layer 3 U2N relay.

An example of enhancement involves a U2N relay authorization. In particular, prior to the U2N relay discovery, the U2N relay authorization can occur, whereby the 5GC 530 authorizes the relay UE 520 to provide a U2N relay for emergency services to one or more remote UEs. The relay UE 520 can send capability information to the 5GC 530 indicating its capability to support a U2N relay for emergency services. The capability information indicates the capability of the relay UE 520 to function as a U2N Relay for emergency services. This capability can be indicated to the network as part of NAS Capability in a SGMM Registration message. For instance, the relay UE 520 may set this capability bit in the message based on user input at the relay UE 520, where the user input corresponds to a user's consent to provide relay connectivity for emergency services, or based on a local configuration stored at the relay UE 520 and configuring the relay UE 520 to support this functionality. The 5GC 530 can take into account the UE capability for authorizing emergency relay services for the relay UE 520 in the relay UE's 520 registered PLMN and/or additionally one or more equivalent PLMNs. The 5GC's 530 authorization can be independent of the authorization for normal (e.g., non-emergency services) U2N relay services and/or can be independent of whether the relay UE 520 is allowed emergency services for itself in the current registered PLMN.

Based on a set of factors, including the 5GC′s 530 authorization, the relay UE 520 can determine that the U2N relay for emergency services functionality can be provided to remote UEs. Other factors include, for instance, relay service codes (RSCs) and battery levels. In the context of a layer 3 U2N relay, the relay UE 520 can provide the layer 3 U2N relay for emergency services only with RSCs that require a remote UE to connect to a N3IWF. Additionally or alternatively, the relay UE 520 can provide the layer 3 U2N relay for emergency services when its battery level exceeds a predefined threshold level. For instance, the battery levels can be categorized in three categories: high, medium, low with thresholds of sixty percent and thirty percent (e.g., high is larger than sixty percent, medium is between thirty percent and fifty-nine percent, and low is less than twenty-nine percent). Of course, other categories and threshold levels can be defined and such definition can be stored by the relay UE 520 as local configurations. With the illustrative three categories, the relay UE 510 may support the layer 3 U2N relay for emergency services only when, for instance, its battery level is categorized as high or medium. Additionally or alternatively, information about the battery level can be broadcasted by the relay UE 520 (e.g., during a U2N relay discovery) and used by a remote UE during a U2N relay selection (e.g., as one of the selection factors, where a higher battery level of a first candidate relay UE relative to a second candidate relay UE biases the selection of the first candidate relay UE).

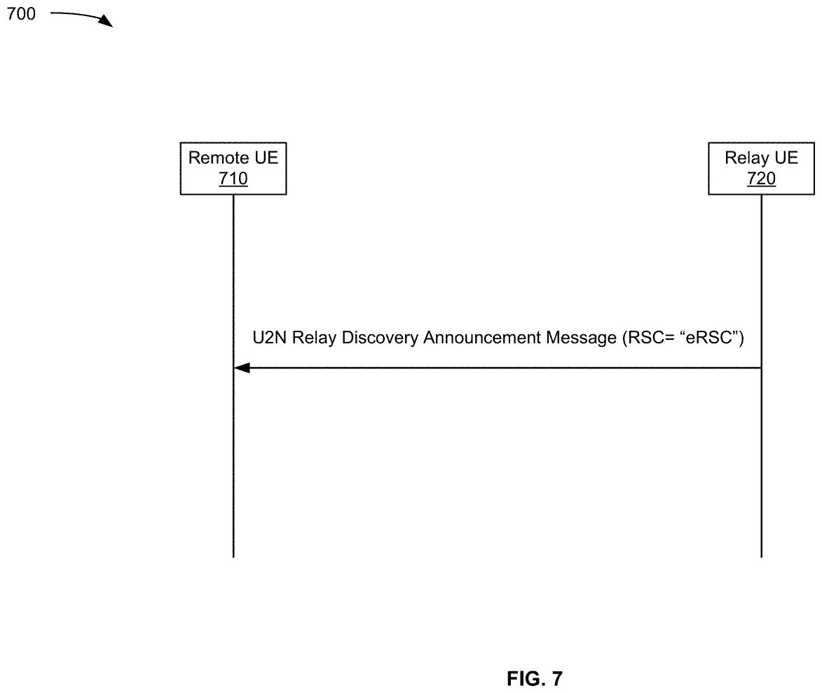

Upon a determination that the U2N relay for emergency services can be provided, the relay UE 520 can participate in a U2N relay discovery with the remote UE 510. As described herein above, the battery level or related category can be sent to the remote UE 510 during this discovery. Another example enhancement relates to indicating the support of the U2N relay for emergency services to the remote UE 510. In this way, when the remote UE 510 is selecting a relay UE from candidate UEs, the remote UE 510 can consider whether such candidate UEs support emergency relay services as one of the selection factors. The support information can be sent as an emergency RSC (eRSC) or as an emergency service indicator (eSI) as part of a model A discovery and/or a model B discovery, as further described in FIGS. 7-10.

Upon discovering that the relay UE 520 supported a U2N relay for emergency services, the remote UE 510 can select the relay UE 520 from among candidate relay UEs that are also discovered. An example enhancement to the U2N relay selection involves emergency services factors. An emergency services factor can include the indication that the relay UE 520 supports relaying emergency services. In this way, the remote UE 510 can select the best U2N relay (e.g., based on the factors described in connection with FIG. 4) in light of the capability indication from the candidate relay UEs indicating support (and/or non-support) of emergency relay functionality. Another emergency services factor can include the battery level. For instance, the remote UE 510 selects the U2N relay for emergency services corresponding to the candidate relay UE that has the highest battery level. Additionally or alternatively, the remote UE 510 can require that the candidate relay UE should have a minimum batter level or category (e.g., should have a medium or high battery level) to be selected.

Following the U2N relay selection, the relay communication can be established. In the context of a layer 3 U2N relay, the establishment can involve establishing a D2D connection between the remote UE 510 and the relay UE 520, and establishing a session between the relay UE 520 and the 5GC 530 on behalf of the remote UE 510, followed by selecting the N3IWF module 540 and establishing a connection between the remote UE 510 and the N3IWF module 540.

Establishing the D2D connection between the remote UE 510 and the relay UE 520 can include the remote UE 510 sending a D2D request to the relay UE 520 on an unlicensed band of the frequency spectrum. In some embodiments, the D2D request message may be transmitted based on any combination of and/or all of a dedicated peer-to-peer protocol, cellular based communications, Wi-Fi based communications, Bluetooth and/or Bluetooth Low Energy based communications, as well as other longer-range and/or shorter-range communication technologies. In some embodiments, the D2D request message may be transmitted based on and/or in conjunction with the 3GPP PC5 communication protocol. In some embodiments, the D2D request message may be transmitted using an emergency channel. In some embodiments, the D2D request message may include information associated with the emergency condition to the potential relay UEs. For example, the remote UE may provide an indication of a type of emergency, the approximate location of the remote UE, and/or other information associated with the emergency condition. Upon registration with the 5GC 530, the relay UE 520 may accept the D2D request and notify the remote UE 510 of acceptance of the D2D request. Additionally, the relay UE 520 may provide the remote UE 510 with information associated with the remote UE 520 registering with the 5GC 530. The D2D connection can provide a layer 3 link with an IP address assigned to the remote UE 510.

An example enhancement to establishing the D2D connection relates to using a cause value related to emergency services (e.g., a cause being “emergency services over the U2N relay”). In particular, the D2D request message can indicate the cause for the request as being for emergency services. The relay UE 520 can use the cause value to select an access class (e.g., AC=2) for access barring, such as an access identity and/or an access category for a unified access control indicating emergency services if an RRC connection establishment is required (e.g., for the PDU session establishment).

Establishing the session between the relay UE 520 and the 5GC 530 can include initiating an emergency attachment procedure on behalf of the remote UE 510 with the 5GC 530 (e.g., with the base station providing the cell on which the rely UE 510 is camped). This attachment procedure can involve establishing a relay PDU session. The emergency attachment procedure may also create and/or allocate a default bearer to an SOS APN for emergency session initiation protocol (SIP) signaling. The 5GC 530 may determine, based on location information of the remote UE 510 (e.g., as provided by the relay UE 520), an appropriate PSAP, such as the PSAP 570. The relay UE 520 may accomplish SIP emergency registration towards the P-CSCF 560. The P-CSCF 560 may facilitate establishment of an RTP path toward the PSAP 570 to establish an emergency SIP session.

An example enhancement to establishing the D2D connection relates to registration and priority. For instance, the relay UE 520 does not initiate de-registration as long as the relay emergency session is ongoing. In other words, establishing a communication session between the relay UE 520 and the 5GC 530 (e.g., the PDU session) is based on a UE-to-network relay registration. A UE-to-network relay de-registration is initiated only after this communication session is terminated. In case of resource constraints in the relay UE 520, the relay UE 520 should give priority to the relayed emergency session. In other words, the communication session (e.g., the PDU session) has a higher priority than another communication function of the relay UE 520. Further, the relay UE 520 indicates in the PDU session establishment that relayed traffic is for emergency services. In this way, the communication is relayed by sending in the PDU session traffic of the remote UE to the core network and indicating that the traffic is for emergency services. However, an explicit indication may not be used if the RSC for emergency services (e.g., eRSC) is a standardized value used during the U2N relay discovery. The 5GC 530 can treat the PDU session for relayed emergency service with the same priority and importance as an emergency service session initiated by the relay UE 520 itself

Selecting the N3IWF module 540 and establishing the connection between the remote UE 510 and the N3IWF module 540 can involve establishing an IPSec tunnel therebetween. An example of this process is described in 3GPP TS23.304 V17.1.0 (2021December), section 6.5.1, the content of which is incorporated herein by reference in its entirety.

Next, an IMS emergency session may be established between the remote UE 510 and the P-CSCF module 560 and this session can support emergency communications (e.g., voice calls, video calls, test messages, etc.) between remote UE 510 and the PSAP 570. Here also several enhancements exist.

An example enhancement relates to the remote UE's 510 location during an IMS emergency communication. Generally, two types of location information can be used: UE-provided location information (UPLI) and network-provided location information (NPLI). In a layer 3 U2N relay case, the emergency communication is established using N3IWF. The same requirements, such as UE IP address (which in this case would correspond to the relay UE's 520 IP Address) can be retrieved by a location retrieval function (LRF) of the network. 3GPP TS 23.167 V17.2.0, (2021September), section 7.5 and Annex L, the content of which is incorporated herein by reference in its entirety, describes techniques for location handling and such techniques can be adopted herein for the remote UE's 510 location determination. Furthermore, the remote UE 510 can include the new radio cell global identifier (NCGI) obtained during the U2N relay discovery in the IMS emergency session request along with a confidence factor for the location. The confidence score can be derived from computing the distance between the remote UE 510 and the relay UE 520 by measurements by the remote UE 510 of side link reference signal received power (SL-RSRP) of a direct connection to the relay UE 520 (e.g., the PC5 link therebetween) or a side link discovery reference signal received power (SD-RSRP) of discovery messages between the remote UE 510 and the relay UE 520.

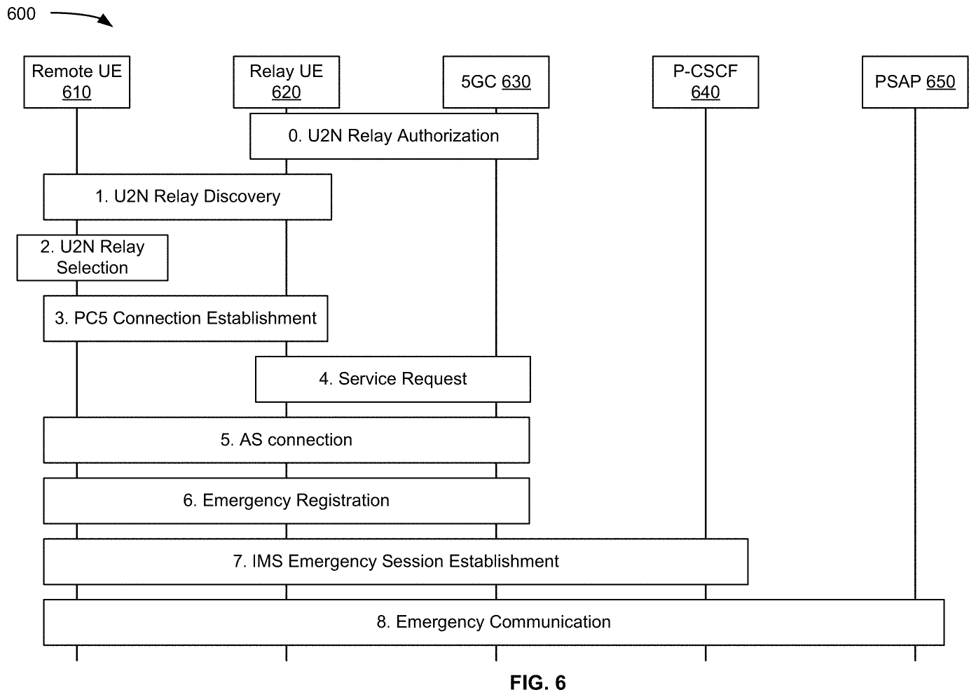

FIG. 6 illustrates an example of a sequence diagram 600 for emergency services over a layer 2 UE-to-network relay, in accordance with some embodiments. The sequence diagram 600 enables multiple enhancements relative to the sequence diagram 400. The enhancements are further described herein below. Similarities between the two sequence diagrams 400 and 600 are not repeated in the interest of brevity of explanation. The sequence diagram 600 involves communications between a remote UE 610, a relay UE 620, a 5G core (5GC) 630, a P-CSCF module 640, and a PSAP 650. In FIG. 6, the relay UE 620 provides a layer 2 U2N relay.

An example of enhancement involves a U2N relay authorization. In particular, prior to the U2N relay discovery, the U2N relay authorization can occur, whereby the 5GC 630 authorizes the relay UE 620 to provide a U2N relay for emergency services to one or more remote UEs. The U2N relay authorization is similar to the one described in connection with FIG. 5 and the similarities are not repeated herein. Whereas the set of factors for a layer 3 U2N relay for emergency services can include RSCs, the RSC factor may not apply for a Layer 2 U2N relay for emergency services. Instead, the relay UE 620 can consider if emergency services are allowed in the cell on which the UE 620 is camped (e.g., an NG-cell). This determination can be based on a broadcast in a system information block (SIB) in the cell IMSEmergencySupport or eCalloverIMSSupport.

Upon a determination that the U2N relay for emergency services can be provided, the relay UE 620 can participate in a U2N relay discovery with the remote UE 610. Similar enhancements related to the broadcast of battery level information and to the broadcast of an indication that the U2N relay supports emergency services are applicable to the layer 2 U2N relay discovery, as further described in FIGS. 7-10.

Upon discovering that the relay UE 620 supported a U2N relay for emergency services, the remote UE 610 can select the relay UE 620 from among candidate relay UEs that are also discovered. An example enhancement to the U2N relay selection involves emergency services factors, such as the one described in FIG. 5. Another example enhancement to the U2N relay selection relates to the PLMN identifier (ID). In particular, the remote UE 610 can ignore the PLMN ID(s) broadcast by the relay UE 620 (and, similarly, other discovered candidate relay UEs) during the selection of a U2N relay for emergency services. Similar to cell selection for a limited service state, emergency service relay selection can be seen as limited services and it is an acceptable relay selection. Further, the remote UE 610 performs emergency registration with a 5G network available through the relay UE 610 (if selected), even when the PLMNs broadcast by the relay UE 610 includes none of the preferred PLMNs for the remote UE 620.

Following the U2N relay selection, the relay communication can be established. In the context of a layer 2 U2N relay, the establishment can involve establishing a D2D connection (e.g., a PC5 connection) between the remote UE 610 and the relay UE 620, a service request of the relay UE 620 to the 5GC 630 for moving the relay UE 620 to a CM_CONNECTED state, followed by establishing an AS connection between the remote UE 610 and the 5GC 630 and an emergency registration of the remote UE 610 with the 5GC 630. Establishing the D2D connection between the remote UE 610 and the relay UE 620 can be based on the 3GPP PC5 protocol. As such, the relay UE 620 and the remote UE 610 can establish a PC5 link.

An example enhancement to establishing the D2D connection relates to using a cause value related to the emergency services (e.g., a cause being “emergency services over the U2N relay”). This enhancement is similar to the corresponding enhancement described in FIG. 5, except that it applies to the service request for the layer 2 U2N relay.

The service request can be part of an RRC establishment with a base station. Priority and registration enhancements similar to the ones described above in FIG. 5 also apply here. Additionally, in the context of a layer 2 U2N relay, the relay UE 620 indicates, in the service request, that the connection established is for relaying emergency registration and traffic from the remote UE. The relay UE 620 treats the radio bearers configured for carrying the remote UE's 610 emergency traffic at the same priority as the relay UE's 620 signaling radio bearers (SRBs). The relay UE 620 can learn that the remote UE 610 is using the layer 2 U2N relay for emergency services based on the cause value indicated by the remote UE 610 in the PC5 Connection establishment phase or, alternatively, by inspecting the establishment cause in a message (e.g., msg3) from the remote UE 610 to the 5GC 630.

During the emergency registration, the remote UE 610, via the relay UE 610, may initiate an emergency attachment procedure (e.g., including registration of the remote UE 610 with the 5GC 630), such as with one or more functions of 5GC 630. The emergency attachment procedure may create and/or allocate a default bearer to an SOS APN for emergency SIP signaling. The 5GC 630 may determine, based on location information of the remote UE 610 (e.g., as provided by the relay UE 620), an appropriate PSAP, such as the PSAP 650. The remote UE 620 may accomplish SIP emergency registration towards the P-CSF 640 module. The P-CSCF module 640 may facilitate establishment of an RTP path toward PSAP 650 and the emergency SIP session is established.

Next, an IMS emergency session may be established between the remote UE 610 and the P-CSCF module 640 and this session can support emergency communications (E.g., voice calls, video calls, test messages, etc.) between remote UE 610 and the PSAP 650. Here also several enhancements exist.

An example enhancement relates to the remote UE's 610 location during an IMS emergency communication. In the context of a layer 2 U2N relay, if the 5GC 630 is using network-based positioning for obtaining the location (e.g., NPLI) of the remote UE 610, then the remote UE 61 can use the NCGI obtained during the U2N discovery to report the enhanced Cell ID. Additionally, the remote UE 610 can include a confidence factor for the location based on computing the distance to the relay UE 620 by measurements on SL-RSRP on the PC5 link between the remote UE 610 and the relay UE 620 and/or SD-RSRP measurements on the discovery messages between the remote UE 610 and the relay UE 620.

Referring back to FIGS. 5 and 6, additional techniques can be used to provide further enhancements relative to the sequence diagram 400 of FIG. 4. An example additional technique relates to the D2D connection between a remote UE and a relay UE. For instance, the relay communication is established based on a direct communication request of the remote UE for emergency services. In this case, the direct communication request is accorded, by the relay UE, a higher priority than a request for a non-emergency service. In other words, the relay UE treats the direct communication request for emergency services at a higher priority than a request for a non-emergency service.

Another example technique relates to limiting the remote UE from initiation more than one emergency session at a time (e.g., the remote UE can initiate only one emergency session at a time). Similarly, the relay UE may receive multiple direct communication requests from different remote UEs for emergency services (e.g., by receiving a first direct communication from a first remote UE and a second direct communication request from a second remote UE). The relay UE can use a prioritization rule to select one of the remote UEs (e.g., the first remote instead of the second remote UE for the UE-to-network relay) to use the relay session (e.g., the U2N relay, such that the relay UE is configured to support only one remote UE at a time for emergency services relay). The prioritization rule indicates a remote UE selection based on a remote UE configured access identity. For instance, the relay UE accepts a request from a remote UE that has been configured with one of the access identities 1-2 or 11-15. A Communication Request can be enhanced to include access identities from the corresponding remote UE (e.g., an access identity of the first remote UE is included in the first direct communication request and corresponds to ID 1-2 or 11-15, thereby biasing the relay UE to select it instead of second remote UE). Additionally or alternatively, the prioritization rule indicates a remote UE selection based on a corresponding contact in a contacts list of the relay UE. A security parameter can be used (such as a signed hash from a remote UE related to the contacts list) for verification by the relay UE. For instance, the first direct communication request includes a security parameter that the relay UE verifies based on the contacts list. Additionally or alternatively, the prioritization rule indicates a remote UE selection based on a first come first serve basis. For instance, the first direct communication request is received prior to the second direct communication request. As such, if more than one request from the same priority level is received, the relay UE accepts the request on the first come first serve basis.

Yet another example technique relates to the response of the relay UE to a direct communication request for emergency services. For instance, the relay UE can send, to the second remote UE (the one that was not selected), a response to the second direct communication request. The response indicates that second direct communication request is denied and/or a cause of the second direct communication request being denied. In this way, the relay UE responds to a direct communication request for emergency services that cannot be accepted with an error cause indicating the status “Relay Busy” so that the corresponding remote UE can trigger a Relay Discovery/Selection again.

FIG. 7 illustrates an example of a sequence diagram 700 for a UE-to-network relay discovery that uses model A, in accordance with some embodiments. The sequence diagram 700 can be implemented as part of a U2N relay discovery, whereby a relay UE 720 indicates to a remote UE 710 the support of a U2N relay (layer 2 or layer 3 as the case may be) for emergency services. For example, the relay UE 720 can send (e.g., broadcast) a U2N discovery announcement message per model A of a U2N relay discovery process. An RSC can be included in this message and its value can be send to a standardized value (e.g., defined in a technical specification of a 5G standard) of an emergency RSC (eRSC). The eRSC value can be recognized by both the relay UE and the remote UE as indicating the support for emergency services.

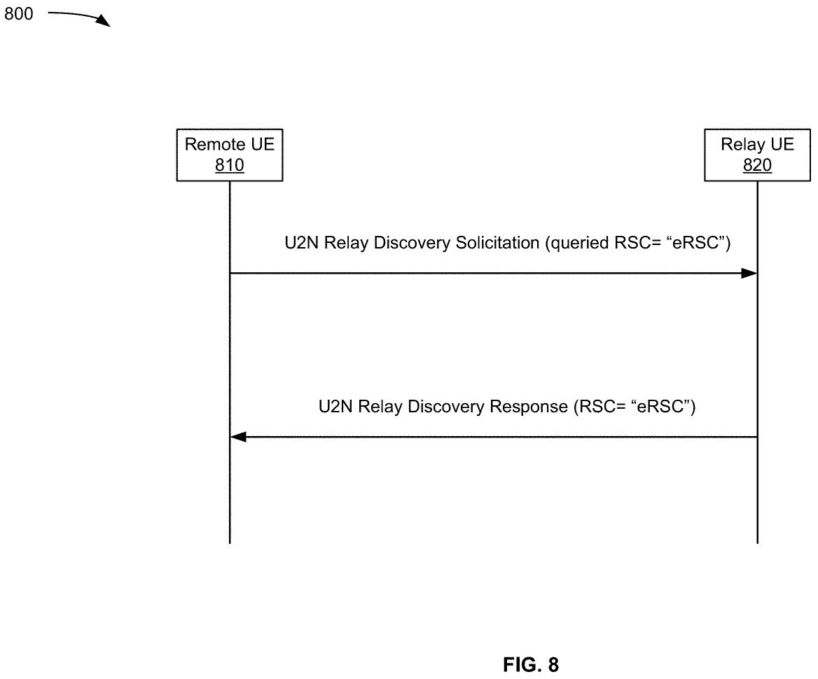

FIG. 8 illustrates an example of a sequence diagram 800 for a UE-to-network relay discovery that uses Model B, in accordance with some embodiments. The sequence diagram 800 can be implemented as part of a U2N relay discovery, whereby a relay UE 820 indicates to a remote UE 810 the support of a U2N relay (layer 2 or layer 3 as the case may be) for emergency services. Here, a model B for the U2N relay discovery is described. Per Model B, the remote UE 810 sends a U2N relay discovery solicitation to the relay UE 820. This solicitation includes a query for an RSC, where the value of the queried RSC is set to the standardized value of the eRSC. The relay UE 820 sends a U2N relay discovery response. An RSC can be included in this response and its value can be send to the standardized value of the eRSC, thereby indicating to the remote UE 810 that the relay UE 820 supports the emergency services relay functionality.

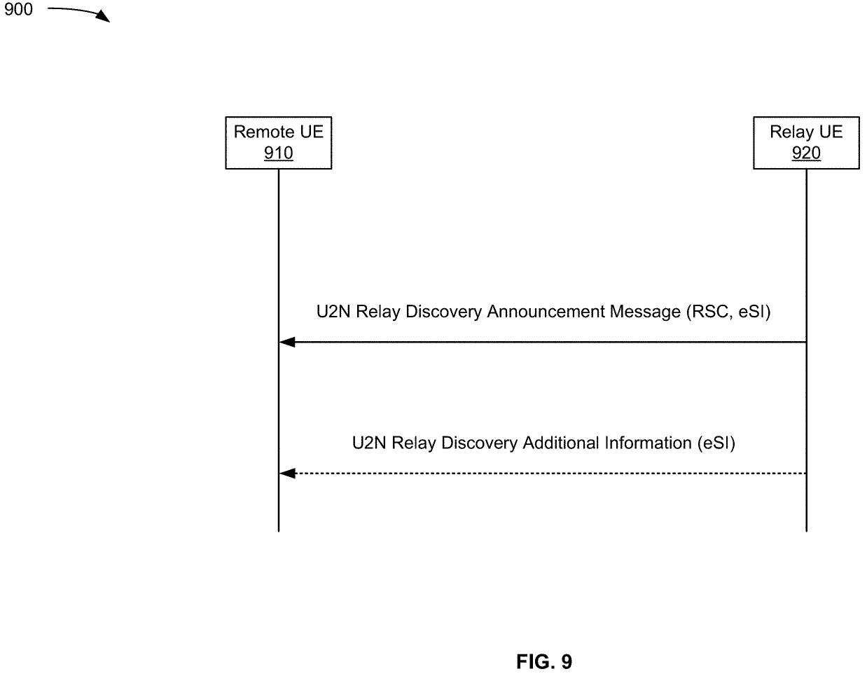

FIG. 9 illustrates another example of a sequence diagram 900 for a UE-to-network relay discovery that uses model A, in accordance with some embodiments. The sequence diagram 900 can be implemented as part of a U2N relay discovery, whereby a relay UE 920 indicates to a remote UE 910 the support of a U2N relay (layer 2 or layer 3 as the case may be) for emergency services. Here, in addition to an RSC, an emergency service indicator (eSI) is used, whereby the RSC and the eSI are separate and different from each other. The eSI can have a value (e.g., a bit value set to “1”) to indicate the capability of supporting emergency services relay functionality, and this capability is indicated as additional information along with the RSC. For example, the relay UE 920 can send (e.g., broadcast) a U2N discovery announcement message per model A of a U2N relay discovery process. An RSC and, separately, an eSI can be included in this message. Optionally, as indicated with a dotted arrow, the eSI can be sent in a message separate than the one carrying RSC, where this other message includes additional U2N relay discovery information, such as the eSI. This message can be used alternatively or additionally to the U2N relay discovery announcement message.

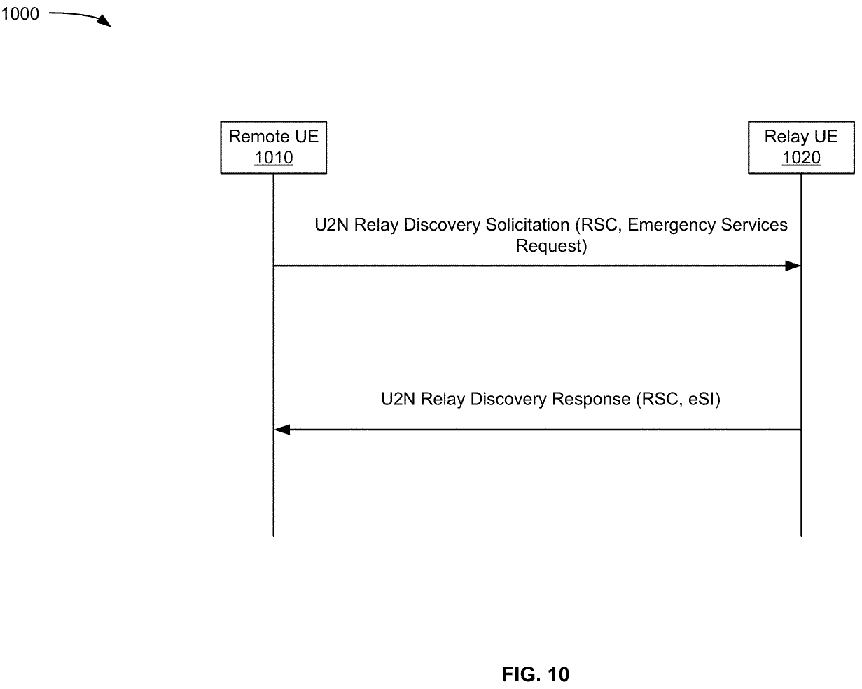

FIG. 10 illustrates another example of a sequence diagram 1000 for a UE-to-network relay discovery that uses model B, in accordance with some embodiments. The sequence diagram 1000 can be implemented as part of a U2N relay discovery, whereby a relay UE 1020 indicates to a remote UE 1010 the support of a U2N relay (layer 2 or layer 3 as the case may be) for emergency services. Here, a model B for the U2N relay discovery is described along with the use of an eSI. Per Model B, the remote UE 1010 sends a U2N relay discovery solicitation to the relay UE 1020. This solicitation includes an RSC and an emergency services request. The relay UE 1020 sends a U2N relay discovery response. An RSC and, separately, the eSI can be included in this response.

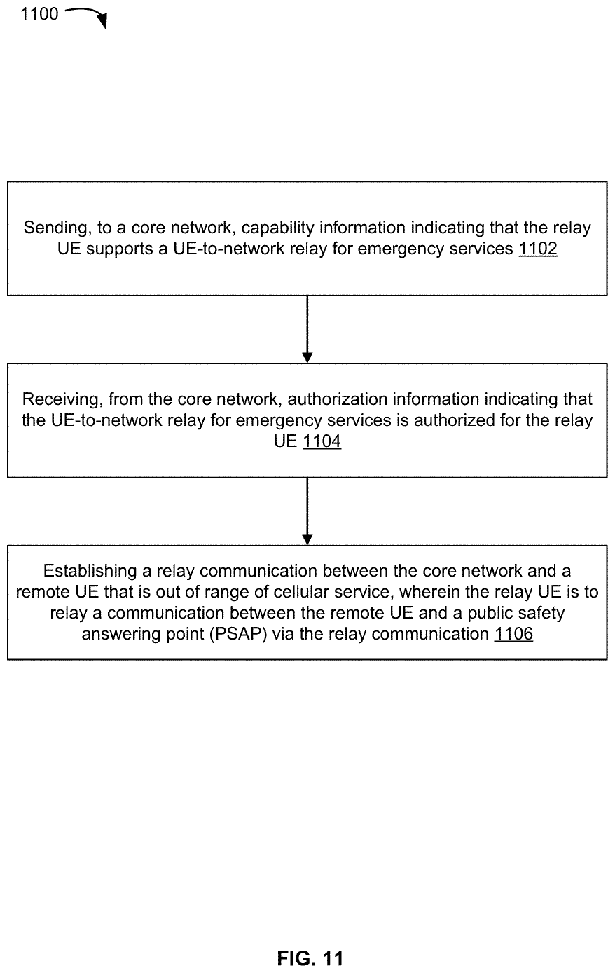

FIG. 11 illustrates an example of an operational flow/algorithmic structure 1100 for a relay UE to participate in relay communications, in accordance with some embodiments. The relay UE is an example of the UE 106, 206, 300, 420, 520, 620, 720, 820, 920, 1020 described herein above or UE 1500 or components thereof, for example, processors 1504. The relay UE can communicate with a remote UE directly and with a core network (e.g., 5GC) via a base station (among other network components).

The operation flow/algorithmic structure 1100 may include, at 1102, sending, to the core network, capability information indicating that the relay UE supports a UE-to-network relay for emergency services. For instance, the capability information is sent as part of NAS capability in a SGMM Registration message and in response to user input at the relay UE indicating consent for this capability and/or based on a local configuration stored at the relay UE indicating the capability support.

The operation flow/algorithmic structure 1100 may include, at 1104, receiving, from the core network, authorization information indicating that the UE-to-network relay for emergency services is authorized for the relay UE. For instance, the authorization information is received based on a determination by the core network that emergency services in the registered PLMN and/or additionally one or more equivalent PLMNs are allowed for the relay UE.

The operation flow/algorithmic structure 1100 may include, at 1106, establishing a relay communication between the core network and the remote UE that is out of range of cellular service, wherein the relay UE is to relay a communication between the remote UE and a public safety answering point (PSAP) via the relay communication. The relay communication can include a layer 2 U2N relay or a layer 3 U2N relay and enhancements described in connection with FIGS. 5-6 can be applied for establishing and using this relay communication.

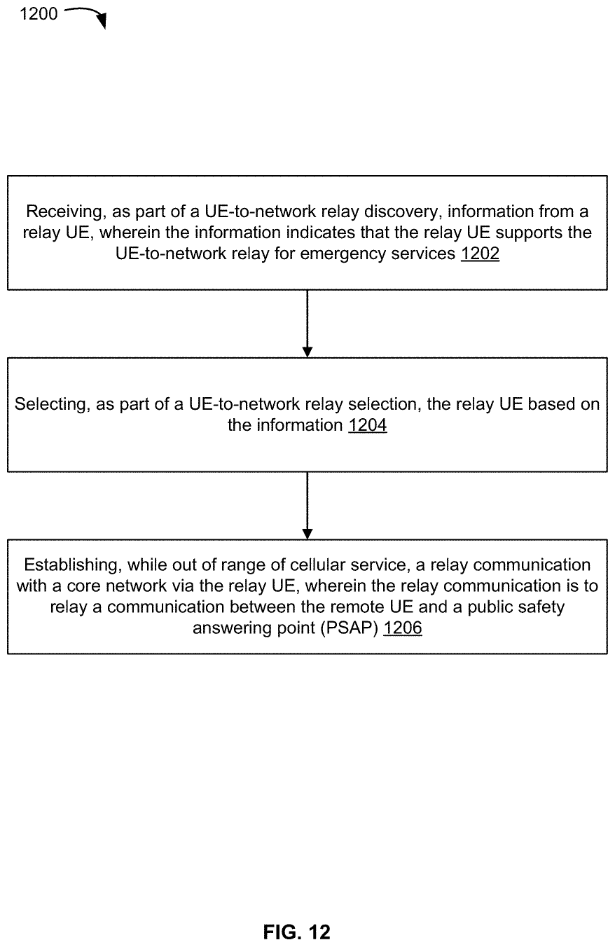

FIG. 12 illustrates an example of an operational flow/algorithmic structure 1200 for a remote UE to participate in relay communications, in accordance with some embodiments. The relay UE is an example of the UE 300, 410, 510, 610, 710, 810, 910, 1010 described herein above or UE 1500 or components thereof, for example, processors 1504. The remote UE can communicate with a relay UE directly and with a core network (e.g., 5GC) via the relay UE and (among other network components).

The operation flow/algorithmic structure 1200 may include, at 1202, receiving, as part of a UE-to-network relay discovery, information from the relay UE, wherein the information indicates that the relay UE supports a UE-to-network relay for emergency services. For instance, the information can include an eRSC and/or an eSI provided using a model A or a model B U2N relay discovery as described in FIGS. 7-10.

The operation flow/algorithmic structure 1200 may include, at 1204, selecting, as part of a UE-to-network relay selection, the relay UE based on the information. For instance, the remote UE selects the relay UE from a candidate set of discovered relay UEs only if the information indicates that the relay UE can provide a U2N relay for emergency services. Other factors, such as the ones described in FIGS. 5-6, can be used for the selection.

The operation flow/algorithmic structure 1200 may include, at 1206, establishing, while out of range of cellular service, a relay communication with the core network via the relay UE, wherein the relay communication is to relay a communication between the remote UE and a public safety answering point (PSAP). The relay communication can include a layer 2 U2N relay or a layer 3 U2N relay and enhancements described in connection with FIGS. 5-6 can be applied for establishing and using this relay communication.

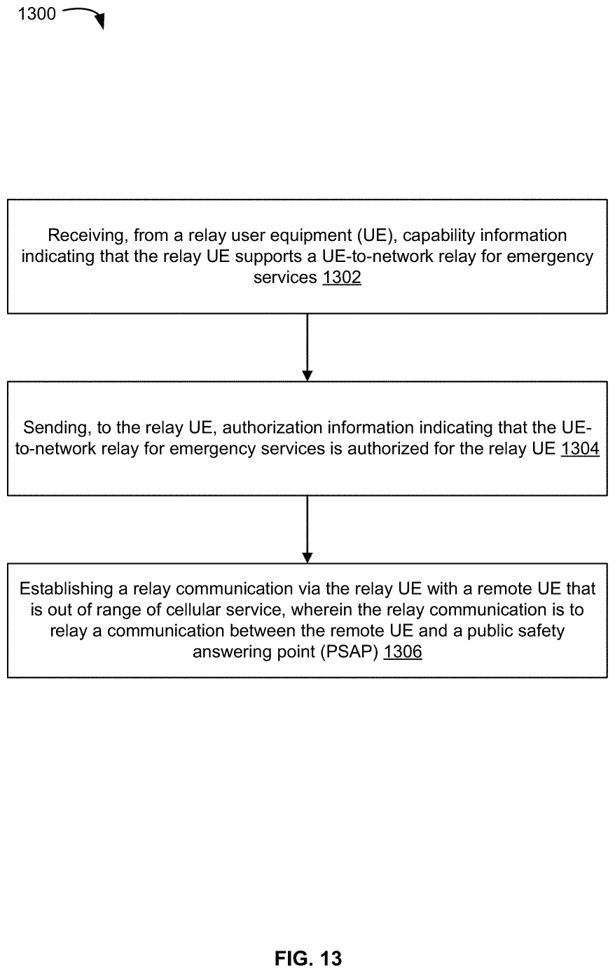

FIG. 13 illustrates an example of an operational flow/algorithmic structure 1300 for a core network to participate in relay communications, in accordance with some embodiments. The core network is an example of the 5GC described in connection with FIGS. 1-2 and 5-6. The core network can communicate with a relay UE via a base station (among other network components) and with a remote UE via the relay UE (also among other network components).

The operation flow/algorithmic structure 1300 may include, at 1302, from a relay user equipment (UE), capability information indicating that the relay UE supports a UE-to-network relay for emergency services. For instance, the capability information is received as part of NAS capability in a SGMM Registration message.

The operation flow/algorithmic structure 1300 may include, at 1304, sending, to the relay UE, authorization information indicating that the UE-to-network relay for emergency services is authorized for the relay UE. The authorization information can be sent based on a determination by the core network that emergency services in the registered PLMN and/or additionally one or more Equivalent PLMNs are allowed for the relay UE.

The operation flow/algorithmic structure 1300 may include, at 1306, establishing a relay communication via the relay UE with the remote UE that is out of range of cellular service, wherein the relay communication is to relay a communication between the remote UE and a public safety answering point (PSAP). The relay communication can include a layer 2 U2N relay or a layer 3 U2N relay and enhancements described in connection with FIGS. 5-6 can be applied for establishing and using this relay communication.

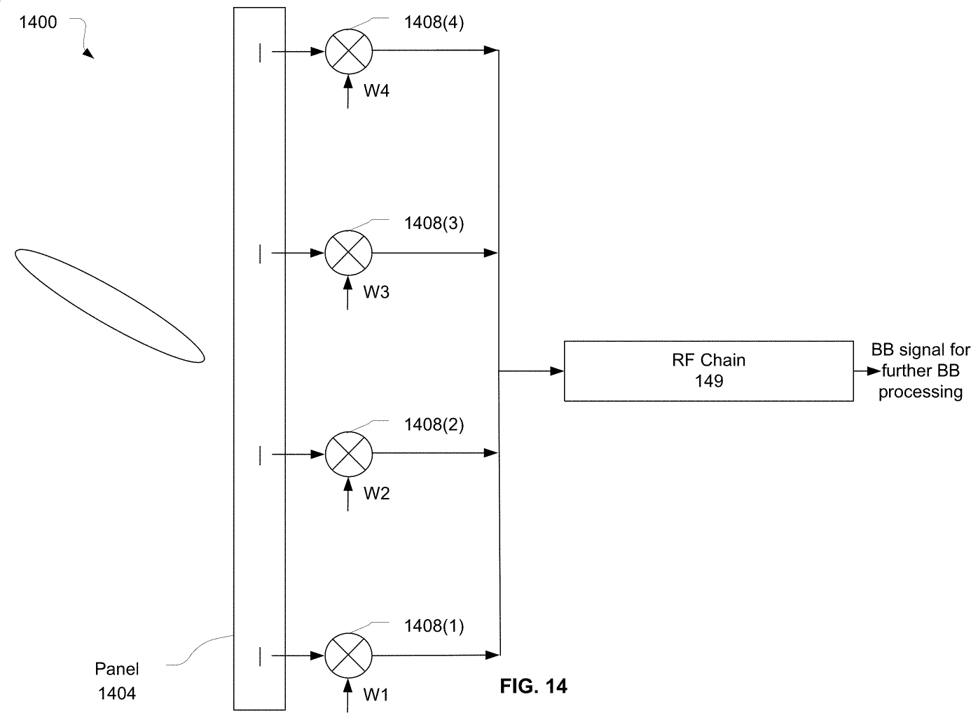

FIG. 14 illustrates receive components 1400 of the UE 106, in accordance with some embodiments. The receive components 1400 may include an antenna panel 1404 that includes a number of antenna elements. The panel 1404 is shown with four antenna elements, but other embodiments may include other numbers.

The antenna panel 1404 may be coupled to analog beamforming (BF) components that include a number of phase shifters 1408(1)-1408(4). The phase shifters 1408(1)-1408(4) may be coupled with a radio-frequency (RF) chain 1412. The RF chain 1412 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1408(1)-1408(4) to provide a receive beam at the antenna panel 1404. These BF weights may be determined based on the channel-based beamforming.

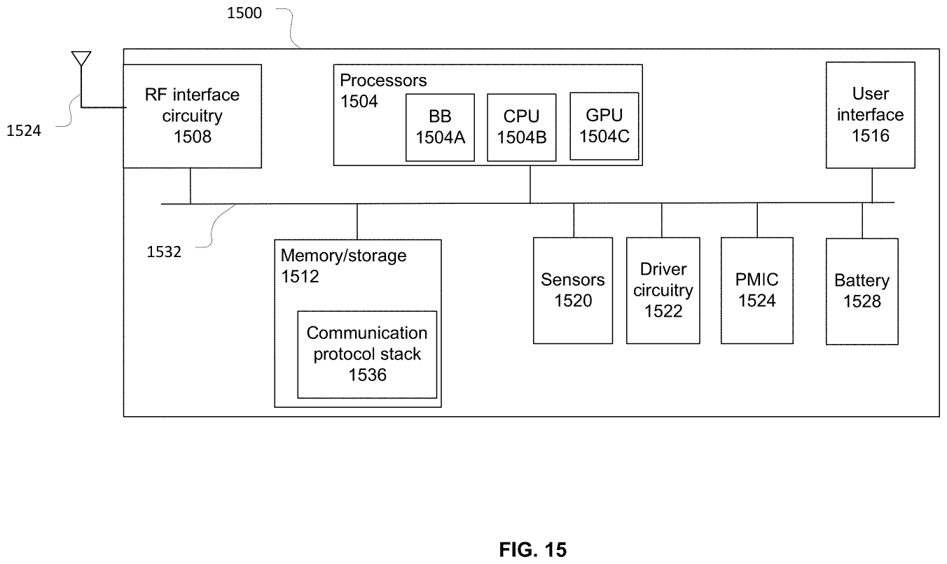

FIG. 15 illustrates a UE 1500, in accordance with some embodiments. The UE 1500 may be similar to and substantially interchangeable with UE 106 of FIG. 1.

Similar to that described above with respect to UE 124, the UE 1500 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1500 may include processors 1504, RF interface circuitry 1508, memory/storage 1512, user interface 1516, sensors 1520, driver circuitry 1522, power management integrated circuit (PMIC) 1524, and battery 1528. The components of the UE 1500 may be implemented as integrated circuits (ICs), portions thereof, discrete electronic devices, or other modules, logic, hardware, software, firmware, or a combination thereof The block diagram of FIG. 15 is intended to show a high-level view of some of the components of the UE 1500. However, some of the components shown may be omitted, additional components may be present, and different arrangements of the components shown may occur in other implementations.

The components of the UE 1500 may be coupled with various other components over one or more interconnects 1532, which may represent any type of interface, input/output, bus (local, system, or expansion), transmission line, trace, optical connection, etc. that allows various circuit components (on common or different chips or chipsets) to interact with one another.

The processors 1504 may include processor circuitry such as, for example, baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage 1512 to cause the UE 1500 to perform operations as described herein.

In some embodiments, the baseband processor circuitry 1504A may access a communication protocol stack 1536 in the memory/storage 1512 to communicate over a 3GPP compatible network. In general, the baseband processor circuitry 1504A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1508.

The baseband processor circuitry 1504A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1504A may also access group information 1524 from memory/storage 1512 to determine search space groups in which a number of repetitions of a PDCCH may be transmitted.

The memory/storage 1512 may include any type of volatile or non-volatile memory that may be distributed throughout the UE 1500. In some embodiments, some of the memory/storage 1512 may be located on the processors 1504 themselves (for example, L1 and L2 cache), while other memory/storage 1512 is external to the processors 1504 but accessible thereto via a memory interface. The memory/storage 1512 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1508 may include transceiver circuitry and a radio frequency front module (RFEM) that allows the UE 1500 to communicate with other devices over a radio access network. The RF interface circuitry 1508 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1524 and proceed to filter and amplify (with a low-noise amplifier) the signal. The signal may be provided to a receiver of the transceiver that down-converts the RF signal into a baseband signal that is provided to the baseband processor of the processors 1504.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1524.

In various embodiments, the RF interface circuitry 1508 may be configured to transmit/receive signals in a manner compatible with NR access technologies.

The antenna 1524 may include a number of antenna elements that each convert electrical signals into radio waves to travel through the air and to convert received radio waves into electrical signals. The antenna elements may be arranged into one or more antenna panels. The antenna 1524 may have antenna panels that are omnidirectional, directional, or a combination thereof to enable beamforming and multiple input, multiple output communications. The antenna 1524 may include microstrip antennas, printed antennas fabricated on the surface of one or more printed circuit boards, patch antennas, phased array antennas, etc. The antenna 1524 may have one or more panels designed for specific frequency bands including bands in FR1 or FR2.

The user interface circuitry 1516 includes various input/output (I/O) devices designed to enable user interaction with the UE 1500. The user interface 1516 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1500.

The sensors 1520 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1522 may include software and hardware elements that operate to control particular devices that are embedded in the UE 1500, attached to the UE 1500, or otherwise communicatively coupled with the UE 1500. The driver circuitry 1522 may include individual drivers allowing other components to interact with or control various input/output (I/O) devices that may be present within, or connected to, the UE 1500. For example, driver circuitry 1522 may include a display driver to control and allow access to a display device, a touchscreen driver to control and allow access to a touchscreen interface, sensor drivers to obtain sensor readings of sensor circuitry 1520 and control and allow access to sensor circuitry 1520, drivers to obtain actuator positions of electro-mechanic components or control and allow access to the electro-mechanic components, a camera driver to control and allow access to an embedded image capture device, audio drivers to control and allow access to one or more audio devices.

The PMIC 1524 may manage power provided to various components of the UE 1500. In particular, with respect to the processors 1504, the PMIC 1524 may control power-source selection, voltage scaling, battery charging, or DC-to-DC conversion.

In some embodiments, the PMIC 1524 may control, or otherwise be part of, various power saving mechanisms of the UE 1500. For example, if the platform UE is in an RRC Connected state, where it is still connected to the RAN node as it expects to receive traffic shortly, then it may enter a state known as Discontinuous Reception Mode (DRX) after a period of inactivity. During this state, the UE 1500 may power down for brief intervals of time and thus save power. If there is no data traffic activity for an extended period of time, then the UE 1500 may transition off to an RRC Idle state, where it disconnects from the network and does not perform operations such as channel quality feedback, handover, etc. The UE 1500 goes into a very low power state and it performs paging where again it periodically wakes up to listen to the network and then powers down again. The UE 1500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1528 may power the UE 1500, although in some examples the UE 1500 may be mounted deployed in a fixed location, and may have a power supply coupled to an electrical grid. The battery 1528 may be a lithium ion battery, a metal-air battery, such as a zinc-air battery, an aluminum-air battery, a lithium-air battery, and the like. In some implementations, such as in vehicle-based applications, the battery 1528 may be a typical lead-acid automotive battery.

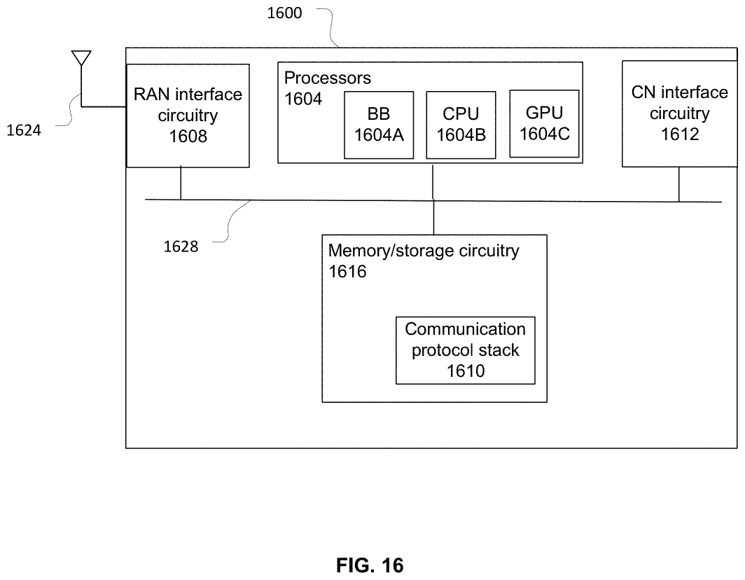

FIG. 16 illustrates a gNB 1600, in accordance with some embodiments. The gNB node 1600 may be similar to and substantially interchangeable with the base station 104 of FIG. 1.

The gNB 1600 may include processors 1604, RF interface circuitry 1608, core network (CN) interface circuitry 1612, and memory/storage circuitry 1616.

The components of the gNB 1600 may be coupled with various other components over one or more interconnects 1628.

The processors 1604, RF interface circuitry 1608, memory/storage circuitry 1616 (including communication protocol stack 1610), antenna 1624, and interconnects 1628 may be similar to like-named elements shown and described with respect to FIG. 10.

The CN interface circuitry 1612 may provide connectivity to a core network, for example, a 5^{th} Generation Core network (5GC) using a 5GC-compatible network interface protocol such as carrier Ethernet protocols, or some other suitable protocol. Network connectivity may be provided to/from the gNB 1600 via a fiber optic or wireless backhaul. The CN interface circuitry 1612 may include one or more dedicated processors or FPGAs to communicate using one or more of the aforementioned protocols. In some implementations, the CN interface circuitry 1612 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method that comprises: sending, to a core network, capability information indicating that a relay UE supports a UE-to-network relay for emergency services; receiving, from the core network, authorization information indicating that the UE-to-network relay for emergency services is authorized for the relay UE; and establishing a relay communication between the core network and a remote UE that is out of range of cellular service, wherein the relay UE is to relay a communication between the remote UE and a public safety answering point (PSAP) is via the relay communication.

Example 2 includes a method of example 1, wherein the capability information is sent as part of non-access stratum (NAS) capability information in a mobility management message.

Example 3 includes a method of any of examples 1-2, wherein the capability information is sent based on user input at the relay UE or on a configuration stored at the UE.

Example 4 includes a method of any of examples 1-3, wherein the UE-to-network relay is a layer 2 UE-to-network relay, and further comprising: determining that emergency services are allowed in a cell on which the relay UE is camped; and determining that the layer 2 UE-to-network relay for emergency services is to be provided based on the UE-to-network relay for emergency services being authorized and on the emergency services being allowed.

Example 5 includes a method of any of examples 1-3, wherein the UE-to-network relay is a layer 3 UE-to-network relay, and further comprising: determining that the layer 3 UE-to-network relay supports emergency services with relay service code (RSC) associated with a connection to a non-third generation partnership project interworking function (N3IWF); and determining that the UE-to-network relay for emergency services is to be provided based on the UE-to-network relay for emergency services being authorized and on the RSC.

Example 6 includes a method of any of examples 1-5, further comprising: determining a battery level of the relay UE; and determining that the UE-to-network relay for emergency services is to be provided based on the UE-to-network relay for emergency services being authorized and on the battery level.

Example 7 includes a method of example 6, further comprising: sending, to the remote UE, an indication of the battery level as part of a UE-to-network relay discovery.

Example 8 includes a method of any of examples 1-7, further comprising: broadcasting a UE-to-network layer discovery announcement as part of a UE-to-network relay discovery, wherein the UE-to-network layer discovery announcement includes an emergency relay service code indicating that the relay UE supports connectivity for emergency services.

Example 9 includes a method of any of examples 1-7, further comprising: receiving, from the remote UE, a UE-to-network layer discovery solicitation as part of a UE-to-network relay discovery, wherein the UE-to-network layer discovery solicitation indicates a query for an emergency relay service code; and sending, to the remote UE, a UE-to-network layer discovery response as part of the UE-to-network relay discovery, wherein the UE-to-network layer discovery response includes the emergency relay service code indicating that the relay UE supports connectivity for emergency services.

Example 10 includes a method of any of examples 1-7, further comprising: broadcasting a UE-to-network layer discovery announcement as part of a UE-to-network relay discovery, wherein the UE-to-network layer discovery announcement includes a relay service code (RSC) and an emergency service indicator separate from the RSC.

Example 11 includes a method of any of examples 1-7, further comprising: receiving, from the remote UE, a UE-to-network layer discovery solicitation as part of a UE-to-network relay discovery, wherein the UE-to-network layer discovery solicitation indicates a query for a relay service code (RSC) and an emergency services request; and sending, to the remote UE, a UE-to-network layer discovery response as part of the UE-to-network relay discovery, wherein the UE-to-network layer discovery response includes the RSC and an emergency service indicator separate from the RSC.

Example 12 includes a method of any of examples 1-11, further comprising: receiving, from the remote UE, a message requesting the relay communication, wherein the message includes an indication that the relay communication is requested for emergency services; and selecting, based on the indication that the relay communication is requested for emergency services, an access identity or an access category for evaluating radio access barring.

Example 13 includes a method of any of examples 1-12, wherein establishing the relay communication comprises establishing a communication session between the relay UE and the core network based on a UE-to-network relay registration, wherein a UE-to-network relay de-registration is initiated only after the communication session is terminated.

Example 14 includes a method of any of examples 1-13, wherein establishing the relay communication comprises establishing a communication session between the relay UE and the core network, wherein the communication session has a higher priority than another communication session of the relay UE.

Example 15 includes a method of any of examples 1-14, wherein establishing the relay communication comprises establishing a protocol data unit (PDU) session for a layer 3 UE-to-network relay, wherein the communication is relayed by sending in the PDU session traffic of the remote UE to the core network and indicating that the traffic is for emergency services.

Example 16 includes a method of any of examples 1-14, wherein establishing the relay communication comprises establishing a protocol data unit (PDU) session for a layer 3 UE-to-network relay, wherein the communication is relayed by sending in the PDU session traffic of the remote UE to the core network, wherein the traffic is sent without an indication the traffic is for emergency services based on an emergency relay service code.

Example 17 includes a method of any of examples 1-14, wherein the UE-to-network relay is a layer 2 UE-to-network relay, and wherein establishing the relay communication comprises establishing a connection to a radio access network (RAN) by indicating that the connection is established for relaying emergency registration and traffic from the remote UE.

Example 18 includes a method of example 17, wherein the traffic of the remote UE is accorded, by the relay UE, a same priority as a signaling radio bearer of the relay UE.

Example 19 includes a method of example 17, further comprising: determining that the relay communication is for emergency services based on a cause value indicated by the remote UE in a direct link connection establishment phase or on an establishment cause indicated in a message of the remote UE to the core network.

Example 20 includes a method of any of examples 1-19, wherein the relay communication is established based on a direct communication request of the remote UE for emergency services, wherein the direct communication request is accorded, by the relay UE, a higher priority than a request for a non-emergency service.

Example 21 includes a method of any of examples 1-20, wherein the remote UE is a first remote UE, and further comprising: receiving, from the first remote UE and a second remote UE, a first direct communication request and a second direct communication request, respectively; and selecting, based on a prioritization rule, the first remote UE instead of the second remote UE for the UE-to-network relay.

Example 22 includes a method of example 21, wherein the prioritization rule indicates a remote UE selection based on access identities configured in the remote UE.

Example 23 includes a method of example 22, wherein an access identity of the first remote UE is included in the first direct communication request.

Example 24 includes a method of example 21, wherein the prioritization rule indicates a remote UE selection based on a corresponding contact in a contacts list of the relay UE.

Example 25 includes a method of example 24, wherein the first direct communication request includes a security parameter that the relay UE verifies based on the contacts list.

Example 26 includes a method of example 21, wherein the prioritization rule indicates a remote UE selection based on a first come first serve basis, wherein the first direct communication request is received prior to the second direct communication request.

Example 27 includes a method of example 21, further comprising: sending, to the second remote UE, a response to the second direct communication request, wherein the response indicates that second direct communication request is denied or a cause of the second direct communication request being denied.

Example 28 includes a method comprising: receiving, as part of a UE-to-network relay discovery, information from a relay UE, wherein the information indicates that the relay UE supports a UE-to-network relay for emergency services; selecting, as part of a UE-to-network relay selection, the relay UE based on the information; and establishing, while out of range of cellular service, a relay communication with a core network via the relay UE, wherein the relay communication is to relay a communication between a remote UE and a public safety answering point (PSAP).

Example 29 includes a method of example 28, wherein receiving the information comprises receiving a UE-to-network layer discovery announcement as part of a UE-to-network relay discovery, wherein the UE-to-network layer discovery announcement includes an emergency relay service code indicating that the relay UE supports connectivity for emergency services.

Example 30 includes a method of example 28, wherein receiving the information comprises receiving a message as part of a UE-to-network relay discovery, wherein the message includes an emergency relay service code indicating that the relay UE supports connectivity for emergency services.

Example 31 includes a method of example 28, further comprising: sending, to the relay UE, a message as part of a UE-to-network relay discovery, wherein the message indicates a query for an emergency relay service code, wherein receiving the information comprises receiving a response as part of the UE-to-network relay discovery, wherein the response includes the emergency relay service code indicating that the relay UE supports connectivity for emergency services.

Example 32 includes a method of example 28, wherein receiving the information comprises receiving a message as part of a UE-to-network relay discovery, wherein the message includes a relay service code (RSC) and an emergency service indicator separate from the RSC.

Example 33 includes a method of example 28, further comprising: sending, to the relay UE, a message as part of a UE-to-network relay discovery, wherein the message indicates a query for a relay service code (RSC) and an emergency services request, wherein receiving the information comprises receiving a response as part of the UE-to-network relay discovery, wherein the response includes the RSC and an emergency service indicator separate from the RSC.

Example 34 includes a method of any of examples 28-33, further comprising: receiving an indication of the battery level of the relay UE, wherein the relay UE is selected further based at least in part on the battery level.

Example 35 includes a method of any of examples 28-34, wherein the relay UE is selected independently of a public land mobile network (PLMN) identifier indicated by the relay UE.

Example 36 includes a method of any of examples 28-35, wherein establishing the relay communication comprises performing an emergency registration with the core network via the relay UE, wherein a public land mobile network (PLMN) broadcast of the relay UE excludes a preferred PLMN of the remote UE.

Example 37 includes a method of any of examples 28-36, further comprising:

sending, in the relay communication, location information to the core network, wherein the location information is based on a new radio cell global identifier (NCGI) determined by the remote UE during the UE-to-network relay discovery.

Example 38 includes a method of example 37, wherein the location information further indicates a location confidence factor associated with a distance between the remote

UE and the relay UE, wherein the location confidence factor is determined based on measurements by the remote UE of side link reference signal received power (SL-RSRP) of a direct connection to the relay UE or a side link discovery reference signal received power (SD-RSRP) of discovery messages.

Example 39 includes a method of any of examples 28-38, establishing the relay communication comprises establishing an internet protocol multimedia subsystem (IMS) session between the remote UE and a proxy-call session control function (P-CSCF), and further comprising: sending, in the IMS session, a new radio cell global identifier (NCGI) determined by the remote UE during the UE-to-network relay discovery and a location confidence factor associated with a distance between the remote UE and the relay UE.

Example 40 includes a method of any of examples 28-39, wherein the remote UE is configured to establish only one emergency service session at a time.

Example 41 includes a method comprising: receiving, from a relay user equipment (UE), capability information indicating that the relay UE supports a UE-to-network relay for emergency services; sending, to the relay UE, authorization information indicating that the UE-to-network relay for emergency services is authorized for the relay UE; and establishing a relay communication via the relay UE with a remote UE that is out of range of cellular service, wherein the relay communication is to relay a communication between the remote UE and a public safety answering point (PSAP).

Example 42 includes a method a of example 41, wherein the authorization information is associated with one or more public land mobile networks (PLMNs).

Example 43 includes a method of any of examples 41-42, wherein establishing the relay communication comprises establishing a protocol data unit (PDU) session with the relay UE for a layer 3 UE-to-network relay, wherein the PDU session is accorded, by the core network, a same priority as an emergency service session initiated by the relay UE.

Example 44 includes a UE comprising means to perform one or more elements of a method described in or related to any of the examples 1-40.

Example 45 includes one or more non-transitory computer-readable media comprising instructions to cause a UE, upon execution of the instructions by one or more processors of the UE, to perform one or more elements of a method described in or related to any of the examples 1-40.

Example 46 includes a UE comprising logic, modules, or circuitry to perform one or more elements of a method described in or related to any of the examples 1-40.

Example 47 includes a UE comprising: one or more processors and one or more computer-readable media comprising instructions that, when executed by the one or more processors, cause the one or more processors to perform one or more elements of a method described in or related to any of the examples 1-40.

Example 48 includes a system comprising means to perform one or more elements of a method described in or related to any of the examples 1-40.

Example 49 includes a core network comprising means to perform one or more elements of a method described in or related to any of the examples 41-43.

Example 50 includes one or more non-transitory computer-readable media comprising instructions to cause a core network, upon execution of the instructions by one or more processors of the core network, to perform one or more elements of a method described in or related to any of the examples 41-43.

Example 51 includes a core network comprising logic, modules, or circuitry to perform one or more elements of a method described in or related to any of the examples 41-43.

Example 52 includes a core network comprising: one or more processors and one or more computer-readable media comprising instructions that, when executed by the one or more processors, cause the one or more processors to perform one or more elements of a method described in or related to any of the examples 41-43.

Example 53 includes a system comprising means to perform one or more elements of a method described in or related to any of the examples 41-43.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. A relay user equipment (UE) comprising:
one or more processors; and
one or more memory storing instructions that, upon execution by the one or more processors, configure the relay UE to:
send, to a core network, capability information indicating that the relay UE supports a UE-to-network relay for emergency services;
receive, from the core network, authorization information indicating that the UE-to-network relay for emergency services is authorized for the relay UE; and
establish a relay communication between the core network and a remote UE that is out of range of cellular service, wherein the relay UE is to relay a communication between the remote UE and a public safety answering point (PSAP) is via the relay communication.

2. The relay UE of claim 1, wherein the capability information is sent as part of non-access stratum (NAS) capability information in a mobility management message.

3. The relay UE of claim 1, wherein the capability information is sent based on user input at the relay UE or on a configuration stored at the UE.

4. The relay UE of claim 1, wherein the UE-to-network relay is a layer 2 UE-to-network relay, and wherein the execution of the instructions further configures the relay UE to:
determine that emergency services are allowed in a cell on which the relay UE is camped; and
determine that the layer 2 UE-to-network relay for emergency services is to be provided based on the UE-to-network relay for emergency services being authorized and on the emergency services being allowed.

5. The relay UE of claim 1, wherein the UE-to-network relay is a layer 3 UE-to-network relay, and wherein the execution of the instructions further configures the relay UE to:
determine that the layer 3 UE-to-network relay supports emergency services with relay service code (RSC) associated with a connection to a non-third generation partnership project interworking function (N3IWF); and
determine that the UE-to-network relay for emergency services is to be provided based on the UE-to-network relay for emergency services being authorized and on the RSC.

6. The relay UE of claim 1, wherein the execution of the instructions further configures the relay UE to:
determine a battery level of the relay UE; and
determine that the UE-to-network relay for emergency services is to be provided based on the UE-to-network relay for emergency services being authorized and on the battery level.

7. The relay UE of claim 6, wherein the execution of the instructions further configures the relay UE to:
send, to the remote UE, an indication of the battery level as part of a UE-to-network relay discovery.

8. The relay UE of claim 1, wherein the execution of the instructions further configures the relay UE to:
broadcast a UE-to-network layer discovery announcement as part of a UE-to-network relay discovery, wherein the UE-to-network layer discovery announcement includes an emergency relay service code indicating that the relay UE supports connectivity for emergency services.

9. The relay UE of claim 1, wherein the execution of the instructions further configures the relay UE to:
receive, from the remote UE, a UE-to-network layer discovery solicitation as part of a UE-to-network relay discovery, wherein the UE-to-network layer discovery solicitation indicates a query for an emergency relay service code; and
send, to the remote UE, a UE-to-network layer discovery response as part of the UE-to-network relay discovery, wherein the UE-to-network layer discovery response includes the emergency relay service code indicating that the relay UE supports connectivity for emergency services.

10. The relay UE of claim 1, wherein the execution of the instructions further configures the relay UE to:
broadcast a UE-to-network layer discovery announcement as part of a UE-to-network relay discovery, wherein the UE-to-network layer discovery announcement includes a relay service code (RSC) and an emergency service indicator separate from the RSC.

11. The relay UE of claim 1, wherein the execution of the instructions further configures the relay UE to:
receive, from the remote UE, a UE-to-network layer discovery solicitation as part of a UE-to-network relay discovery, wherein the UE-to-network layer discovery solicitation indicates a query for a relay service code (RSC) and an emergency services request; and
send, to the remote UE, a UE-to-network layer discovery response as part of the UE-to-network relay discovery, wherein the UE-to-network layer discovery response includes the RSC and an emergency service indicator separate from the RSC.

12. The relay UE of claim 1, wherein the execution of the instructions further configures the relay UE to:
receive, from the remote UE, a message requesting the relay communication, wherein the message includes an indication that the relay communication is requested for emergency services; and
select, based on the indication that the relay communication is requested for emergency services, an access identity or an access category for evaluating radio access barring.

13. The relay UE of claim 1, wherein establishing the relay communication comprises establishing a communication session between the relay UE and the core network based on a UE-to-network relay registration, wherein a UE-to-network relay de-registration is initiated only after the communication session is terminated.

14. The relay UE of claim 1, wherein establishing the relay communication comprises establishing a communication session between the relay UE and the core network, wherein the communication session has a higher priority than another communication session of the relay UE.

15. The relay UE of claim 1, wherein establishing the relay communication comprises establishing a protocol data unit (PDU) session for a layer 3 UE-to-network relay, wherein the communication is relayed by sending in the PDU session traffic of the remote UE to the core network and indicating that the traffic is for emergency services.

16. The relay UE of claim 1, wherein establishing the relay communication comprises establishing a protocol data unit (PDU) session for a layer 3 UE-to-network relay, wherein the communication is relayed by sending in the PDU session traffic of the remote UE to the core network, wherein the traffic is sent without an indication the traffic is for emergency services based on an emergency relay service code.

17. The relay UE of claim 1, wherein the UE-to-network relay is a layer 2 UE-to-network relay, and wherein establishing the relay communication comprises establishing a connection to a radio access network (RAN) by indicating that the connection is established for relaying emergency registration and traffic from the remote UE.

18. The relay UE of claim 17, wherein the traffic of the remote UE is accorded, by the relay UE, a same priority as a signaling radio bearer of the relay UE.

19. The relay UE of claim 17, wherein the execution of the instructions further configures the relay UE to:
determine that the relay communication is for emergency services based on a cause value indicated by the remote UE in a direct link connection establishment phase or on an establishment cause indicated in a message of the remote UE to the core network.

20. The relay UE of claim 1, wherein the relay communication is established based on a direct communication request of the remote UE for emergency services, wherein the direct communication request is accorded, by the relay UE, a higher priority than a request for a non-emergency service.

21. The relay UE of claim 1, wherein the remote UE is a first remote UE, and wherein the execution of the instructions further configures the relay UE to:
receive, from the first remote UE and a second remote UE, a first direct communication request and a second direct communication request, respectively; and
select, based on a prioritization rule, the first remote UE instead of the second remote UE for the UE-to-network relay.

22. The relay UE of claim 21, wherein the prioritization rule indicates a remote UE selection based on access identities configured in the remote UE.

23. The relay UE of claim 22, wherein an access identity of the first remote UE is included in the first direct communication request.

24. The relay UE of claim 21, wherein the prioritization rule indicates a remote UE selection based on a corresponding contact in a contacts list of the relay UE.

25. The relay UE of claim 24, wherein the first direct communication request includes a security parameter that the relay UE verifies based on the contacts list.

26. The relay UE of claim 21, wherein the prioritization rule indicates a remote UE election based on a first come first serve basis, wherein the first direct communication request is received prior to the second direct communication request.

27. The relay UE of claim 21, wherein the execution of the instructions further configures the relay UE to:
send, to the second remote UE, a response to the second direct communication request, wherein the response indicates that the second direct communication request is denied or a cause of the second direct communication request being denied.

28. One or more computer-readable storage media storing instructions that, upon execution on a remote user equipment (UE), configure the remote UE to performing operations comprising:
receiving, as part of a UE-to-network relay discovery, information from a relay UE, wherein the information indicates that the relay UE supports a UE-to-network relay for emergency services;
selecting, as part of a UE-to-network relay selection, the relay UE based on the information; and
establishing, while out of range of cellular service, a relay communication with a core network via the relay UE, wherein the relay communication is to relay a communication between the remote UE and a public safety answering point (PSAP).

29. The one or more computer-readable storage media of claim 28, wherein receiving the information comprises receiving a UE-to-network layer discovery announcement as part of the UE-to-network relay discovery, wherein the UE-to-network layer discovery announcement includes an emergency relay service code indicating that the relay UE supports connectivity for emergency services.

30. The one or more computer-readable storage media of claim 28, wherein receiving the information comprises receiving a message as part of the UE-to-network relay discovery, wherein the message includes an emergency relay service code indicating that the relay UE supports connectivity for emergency services.

31. The one or more computer-readable storage media of claim 28, wherein the operations further comprise:
sending, to the relay UE, a message as part of the UE-to-network relay discovery, wherein the message indicates a query for an emergency relay service code, wherein receiving the information comprises receiving a response as part of the UE-to-network relay discovery, wherein the response includes the emergency relay service code indicating that the relay UE supports connectivity for emergency services.

32. The one or more computer-readable storage media of claim 28, wherein receiving the information comprises receiving a message as part of the UE-to-network relay discovery, wherein the message includes a relay service code (RSC) and an emergency service indicator separate from the RSC.

33. The one or more computer-readable storage media of claim 28, wherein the operations further comprise:
sending, to the relay UE, a message as part of the UE-to-network relay discovery, wherein the message indicates a query for a relay service code (RSC) and an emergency services request, wherein receiving the information comprises receiving a response as part of the UE-to-network relay discovery, wherein the response includes the RSC and an emergency service indicator separate from the RSC.

34. The one or more computer-readable storage media of claim 28, wherein the operations further comprise:
receiving an indication of a battery level of the relay UE, wherein the relay UE is selected further based at least in part on the battery level.

35. The one or more computer-readable storage media of claim 28, wherein the relay UE is selected independently of a public land mobile network (PLMN) identifier indicated by the relay UE.

36. The one or more computer-readable storage media of claim 28, wherein establishing he relay communication comprises performing an emergency registration with the core network via the relay UE, wherein a public land mobile network (PLMN) broadcast of the relay UE excludes a preferred PLMN of the remote UE.

37. The one or more computer-readable storage media of claim 28, wherein the operations further comprise:
sending, in the relay communication, location information to the core network, wherein the location information is based on a new radio cell global identifier (NCGI) determined by the remote UE during the UE-to-network relay discovery.

38. The one or more computer-readable storage media of claim 37, wherein the location information further indicates a location confidence factor associated with a distance between the remote UE and the relay UE, wherein the location confidence factor is determined based on measurements by the remote UE of side link reference signal received power (SL-RSRP) of a direct connection to the relay UE or a side link discovery reference signal received power (SD-RSRP) of discovery messages.

39. The one or more computer-readable storage media of claim 28, establishing the relay communication comprises establishing an internet protocol multimedia subsystem (IMS) session between the remote UE and a proxy-call session control function (P-CSCF), and wherein the operations further comprise:
sending, in the IMS session, a new radio cell global identifier (NCGI) determined by the remote UE during the UE-to-network relay discovery and a location confidence factor associated with a distance between the remote UE and the relay UE.

40. The one or more computer-readable storage media of claim 28, wherein the remote UE is configured to establish only one emergency service session at a time.

41. A method implemented by a core network, the method comprising:
receiving, from a relay user equipment (UE), capability information indicating that the relay UE supports a UE-to-network relay for emergency services;
sending, to the relay UE, authorization information indicating that the UE-to-network relay for emergency services is authorized for the relay UE; and
establishing a relay communication via the relay UE with a remote UE that is out of range of cellular service, wherein the relay communication is to relay a communication between the remote UE and a public safety answering point (PSAP).

42. The method of claim 41, wherein the authorization information is associated with one or more public land mobile networks (PLMNs).

43. The method of claim 41, wherein establishing the relay communication comprises establishing a protocol data unit (PDU) session with the relay UE for a layer 3 UE-to-network relay, wherein the PDU session is accorded, by the core network, a same priority as an emergency service session initiated by the relay UE.
